(19) United States
(12) Patent Application Publication
(10) Pub. No.: US 2021/0299900 A1
(43) Pub. Date: Sep. 30, 2021

(54) PRINT SYSTEM, PRINT APPARATUS AND CONTROL METHOD THEREOF, AND INFORMATION PROCESSING APPARATUS AND CONTROL METHOD THEREOF

(71) Applicant: CANON KABUSHIKI KAISHA, Tokyo (JP)

(72) Inventor: Tsuyoshi Muto, Ibaraki (JP)

(21) Appl. No.: 17/207,116

(22) Filed: Mar. 19, 2021

(30) Foreign Application Priority Data
Mar. 31, 2020 (JP) 2020-063777

(51) Int. Cl. B26D 5/00; G06F 3/12; B26F 1/44; B65H 35/00; B65H 5/06

(52) U.S. Cl. CPC B26D 5/00; G06F 3/1208; B65H 5/062; B26F 1/44; B65H 35/0086; G06F 3/1256

(57) ABSTRACT

A print system includes a print apparatus connected to a puncher and an information processing apparatus that communicates with the print apparatus. The print apparatus includes a first transmission unit, a printing unit that prints an image on a sheet, and a control unit that controls the puncher to form punch holes in the sheet. The first transmission unit transmits information indicating a position where the puncher is configured to form the punch holes. The information processing apparatus includes a first reception unit that receives the transmitted information, an acceptance unit that accepts a setting that is based on the received information, and a second transmission unit that transmits the accepted setting to the print apparatus. The control unit of the print apparatus controls the puncher to form the punch holes according to the setting transmitted by the information processing apparatus and received by the print apparatus.

### BACKGROUND

### Field

The present disclosure relates to a print system, a print apparatus and a control method thereof, and an information processing apparatus and a control method thereof.

### Description of the Related Art

Japanese Patent Application Laid-Open No. 2005-257958 discusses a technique in which a screen for a user to specify a punch hole position is displayed on an operation unit of a print apparatus, and a puncher serving as a post-processing apparatus connected to the print apparatus forms punch holes at the position specified by the user on a sheet on which an image is printed.

In the technique discussed in Japanese Patent Application Laid-Open No. 2005-257958, a position where the puncher can form a plurality of punch holes, which is a position in a direction orthogonal to a direction in which the plurality of punch holes is to be aligned, is specified by operating the print apparatus and thus cannot be specified by using an information processing apparatus such as a personal computer (PC) connected to the print apparatus. In addition, positions where punching can be performed and the number thereof may vary depending on the puncher connected to the print apparatus. Thus, in a case where an information processing apparatus is used to specify the position, there is a possibility that the user specifies a position where the puncher cannot perform punching.

### SUMMARY

The present disclosure is directed to allowing a user to specify a punch hole position depending on the capability of a puncher, using an information processing apparatus that issues, to a print apparatus connected to the puncher, an output instruction in which a punch hole position is specified.

According to an aspect of the present disclosure, a print system includes a print apparatus configured to be connected to a puncher, and an information processing apparatus configured to communicate with the print apparatus, wherein the print apparatus includes: a first transmission unit configured to transmit, to the information processing apparatus, information indicating a position where the puncher is configured to form a plurality of punch holes, wherein the position is a position in a direction orthogonal to a direction in which the plurality of punch holes is to be aligned, a printing unit configured to print an image on a sheet, and a control unit configured to control the puncher to form the plurality of punch holes in the sheet on which the image is printed by the printing unit, wherein the information processing apparatus includes: a first reception unit configured to receive the information transmitted by the first transmission unit, an acceptance unit configured to accept a setting that is based on the transmitted information received by the first reception unit, and a second transmission unit configured to transmit the setting accepted by the acceptance unit to the print apparatus, and wherein the control unit of the print apparatus controls the puncher to form the plurality of punch holes according to the setting transmitted by the second transmission unit of the information processing apparatus and received by the print apparatus.

Further features of the present disclosure will become apparent from the following description of exemplary embodiments with reference to the attached drawings.

### BRIEF DESCRIPTION OF THE DRAWINGS

FIG. 1 is a diagram illustrating an example of a hardware configuration of a multifunction peripheral serving as a print apparatus.

FIG. 2 is a diagram illustrating an example of a configuration of an information processing controller unit of the multifunction peripheral.

FIG. 3 is a diagram illustrating an example of a configuration of a production print system.

FIG. 4 is a diagram illustrating an example of a cross section of a punching processing unit of a multifunctional puncher.

FIGS. 5A to 5D are diagrams each illustrating an example of an output produced by the multifunctional puncher to which a two hole punching die is attached.

FIGS. 6A to 6D are diagrams each illustrating another example of the output produced by the multifunctional puncher to which the two hole punching die is attached.

FIG. 7 is a diagram illustrating an example of a sequence in which a print job including punching is executed.

FIG. 8 is a flowchart illustrating an example of a punching process.

FIGS. 9A and 9B are diagrams each illustrating an example of a menu for setting punching.

FIG. 10 is a diagram illustrating an example of a hardware configuration of a personal computer (PC) serving as an information processing apparatus.

### DESCRIPTION OF THE EMBODIMENTS

Exemplary embodiments of the present disclosure will be described below with reference to the drawings. Configurations illustrated in the following exemplary embodiments are examples, and the exemplary embodiments are not limited to the illustrated configurations.

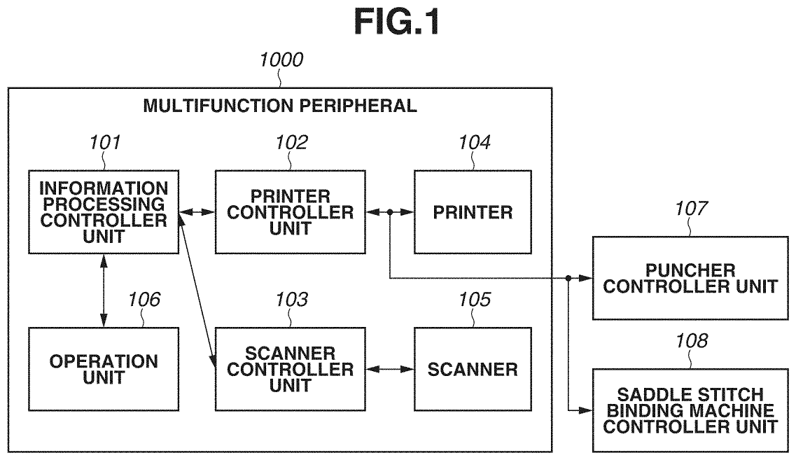

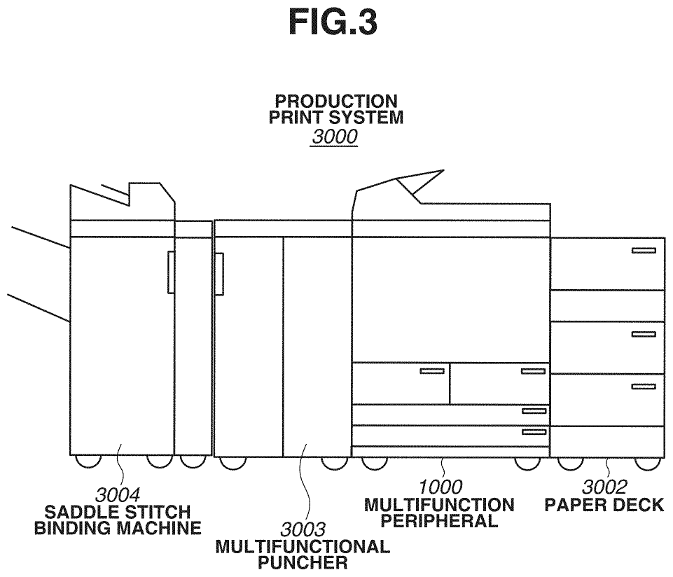

FIG. 1 illustrates an example of a hardware configuration of a multifunction peripheral 1000 serving as a print apparatus according to an exemplary embodiment of the present disclosure. The multifunction peripheral 1000 includes an information processing controller unit 101, a printer controller unit 102, a scanner controller unit 103, a printer 104, a scanner 105, and an operation unit 106. The information processing controller unit 101 controls information processing of the multifunction peripheral 1000, and is connected to the operation unit 106. The printer controller unit 102 and the scanner controller unit 103 are also connected to the information processing controller unit 101. The printer controller unit 102 controls the printer 104 serving as an image output device. The scanner controller unit 103 controls the scanner 105 serving as an image input device. Furthermore, a puncher controller unit 107 and a saddle stitch binding machine controller unit 108 are connected to the printer controller unit 102. The puncher controller unit 107 controls a multifunctional puncher 3003 (see FIG. 3). The saddle stitch binding machine controller unit 108 controls a saddle stitch binding machine 3004 (see FIG. 3).

The printer 104 prints an image on a sheet based on a print job received from a personal computer (PC) serving as an information processing apparatus or based on image data acquired by the scanner 105, for example. The print job received from the PC includes image data corresponding to an image to be printed, and print settings such as 2-in-1, two-sided, stapling, and punching. The scanner 105 scans an image of a document and generates image data based on the scanned image.

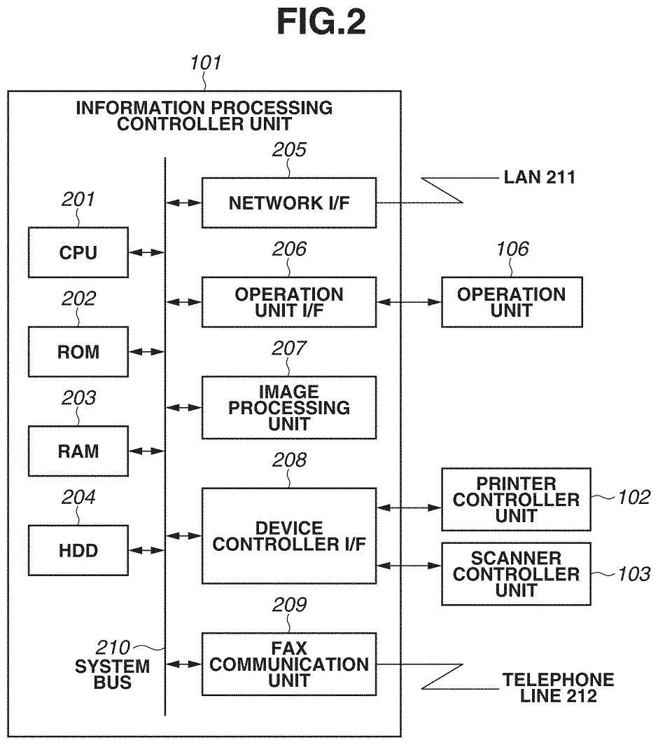

FIG. 2 illustrates an example of a configuration of the information processing controller unit 101 of the multifunction peripheral 1000. The information processing controller unit 101 includes a central processing unit (CPU) 201, a read only memory (ROM) 202, a random access memory (RAM) 203, a hard disk drive (HDD) 204, a network interface (I/F) 205, an operation unit I/F 206, an image processing unit 207, a device controller I/F 208, and a facsimile (fax) communication unit 209.

The CPU 201 executes a boot program stored in the ROM 202 to start an operating system (OS). The CPU 201 executes an application program stored in the HDD 204 on this OS to perform scanning, printing, faxing, and various functions using a network and a memory storage. The OS and the application program detect the occurrence of an error by monitoring the state of each of the units included in the multifunction peripheral 1000.

The RAM 203 is used as a work area of the CPU 201. The RAM 203 provides, in addition to the work area, an image memory area for temporarily storing image data. The HDD 204 stores the application program, image data, various setting values, and logs.

In addition to the ROM 202, the RAM 203, and the HDD 204, the operation unit I/F 206, the device controller I/F 208, the network I/F 205, the image processing unit 207, and the fax communication unit 209 are connected to the CPU 201 via a system bus 210. The operation unit I/F 206 is an interface with the operation unit 106 including a liquid crystal display (LCD) unit that provides for a touch-panel operation.

The CPU 201 executes the OS and the application program, so that screen data corresponding to a screen to be displayed on the operation unit 106 is generated and the generated screen data is output to the operation unit 106 via the operation unit I/F 206. In addition, the CPU 201 executes the OS and the application program, so that information input by a user's operation on the operation unit 106 is acquired via the operation unit I/F 206.

The printer controller unit 102 and the scanner controller unit 103 are connected to the device controller I/F 208. The device controller I/F 208 performs synchronous/asynchronous conversion of image data. Furthermore, the device controller I/F 208 issues instructions to the printer 104, the scanner 105, and a finisher including a puncher, and acquires information about the capability and state of each of the devices.

The network I/F 205 is connected to, for example, a local area network (LAN) 211, and inputs and outputs information from and to various apparatuses via the LAN 211. In addition, the network I/F 205 is used, for example, to receive a print job from a PC 1002 (described below) connected to the LAN 211, and transmit and receive various kinds of data.

The image processing unit 207 performs output image processing on image data to be output to the printer 104, input image processing on image data input from the scanner 105, and other processing such as image rotation, image compression, resolution conversion, color space conversion, and tone conversion.

The fax communication unit 209 is connected to a telephone line 212, and is used to receive fax image data from another facsimile connected to the telephone line 212 and then store the received fax image data in the HDD 204 (which is referred to as a fax receiving function). The image data stored in the HDD 204 is output to the printer 104 via the device controller I/F 208, and the printer 104 prints an image on a sheet based on the image data. The fax communication unit 209 is also used to transmit the image data stored in the HDD 204 to other facsimiles via the telephone line 212.

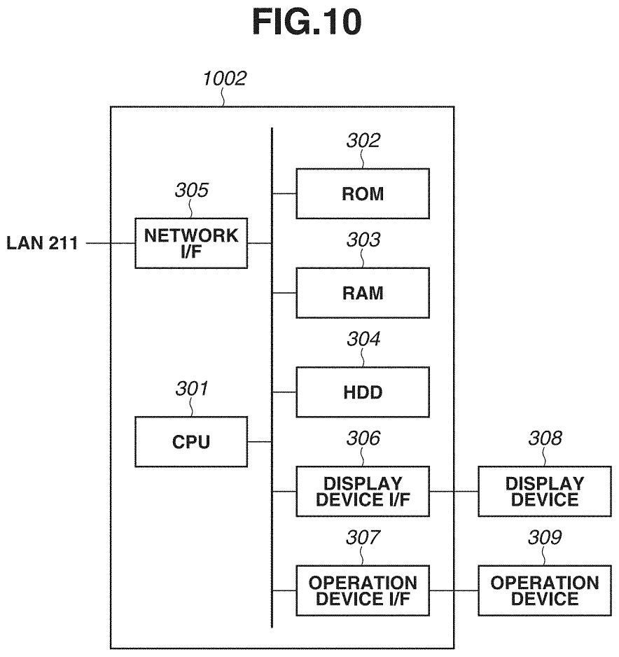

FIG. 10 illustrates an example of a hardware configuration of the PC 1002 serving as an information processing apparatus. The PC 1002 includes a CPU 301, a ROM 302, a RAM 303, an HDD 304, a network I/F 305, a display device I/F 306, and an operation device I/F 307.

The CPU 301 executes a boot program stored in the ROM 302 to start an OS. The CPU 301 executes an application program stored in the HDD 304 on this OS to execute various functions.

The RAM 303 is used as a work area of the CPU 301. The RAM 303 provides, in addition to the work area, an image memory area for temporarily storing image data. The HDD 304 stores the application program, image data, various setting values, and logs.

The network I/F 305 is connected to, for example, the LAN 211, and inputs and outputs information from and to various apparatuses via the LAN 211. In addition, the network I/F 305 is used, for example, to transmit a print job to the multifunction peripheral 1000 connected to the LAN 211, and transmit and receive various kinds of data.

The display device I/F 306 connects, for example, a display device 308 such as a monitor to the PC 1002. The operation device I/F 307 connects, for example, an operation device 309 such as a keyboard or a mouse to the PC 1002.

FIG. 3 illustrates an example of a configuration of a production print system 3000. In this example, the production print system 3000 includes the multifunction peripheral 1000, the multifunctional puncher 3003, the saddle stitch binding machine 3004, and a paper deck 3002.

In this example, the multifunctional puncher 3003 punches holes (performs punching) in a sheet conveyed from the multifunction peripheral 1000. The multifunctional puncher 3003 includes punching dies with different numbers of holes and a creaser for making creases, which are exchangeable by the user. The user can thus perform various punching operations with different numbers and shapes of holes or perform creasing.

The saddle stitch binding machine 3004 can selectively perform stapling, punching, cutting, shifted output, saddle stitch binding, and folding of sheets conveyed from the multifunction peripheral 1000. The saddle stitch binding machine 3004 can also output the conveyed sheets directly to a discharge tray without performing finishing.

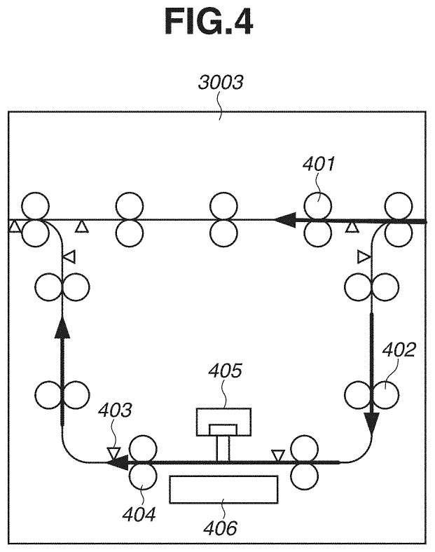

Next, a structure and operation of the multifunctional puncher 3003 will be described with reference to FIG. 4. FIG. 4 illustrates an example of a cross-section of a punching processing unit of the multifunctional puncher 3003. The multifunctional puncher 3003 has mainly two types of sheet conveyance paths. One is a bypass path in the upper portion. The other is a punching path in the lower portion.

In a case where a sheet not subject to punching is conveyed, the sheet sent from the right side is conveyed straight to the left side by bypass rollers 401, and subsequently sent to the saddle stitch binding machine 3004 serving as a finishing unit.

10206405US01

In a case where a sheet subject to punching is conveyed, the sheet is conveyed to the punching path by punching path rollers 402. Skew correction rollers 404 are disposed in the punching path to correct skew of the sheet being conveyed. When the leading edge of the sheet is detected by an alignment sensor 403, the sheet is conveyed so that a punch hole position is right under a punching die 405 having punching blades, and then stopped. The punching die 405 moves downward to punch holes in the sheet. In the case of double punching, the sheet is further moved so that the next punch hole position is right under the punching die 405 and then stopped, and the punching die 405 moves downward to punch holes in the sheet. The punching die 405 according to the present exemplary embodiment is described as a two hole punching die, but is not limited thereto. For example, a four, six, or multiple hole punching die may be used. Punching waste from punching accumulates in a punching waste collection box 406 in the lower portion of the multifunctional puncher 3003 and can be collected.

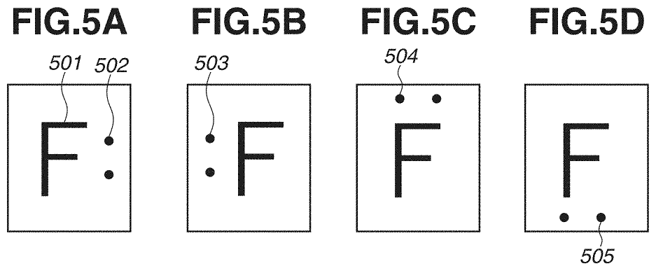

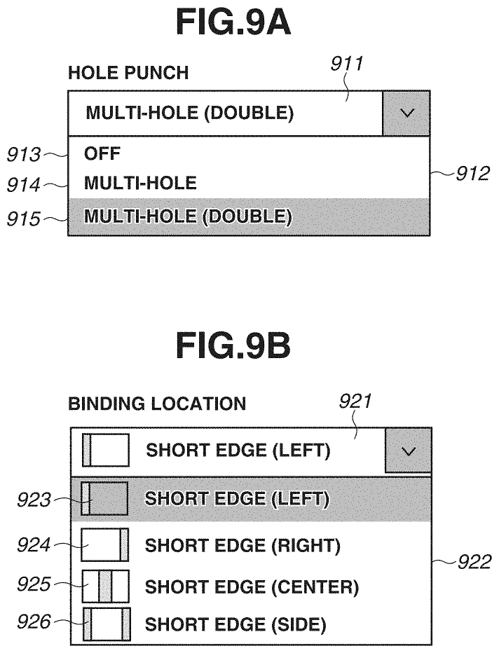

FIGS. 5A to 5D each illustrate an example of an output produced by the multifunctional puncher 3003 to which the two hole punching die 405 is attached. In FIG. 5A, punch holes 502 are formed in one location (line) to the right of an image 501. In FIG. 5B, punch holes 503 are formed to the left of the image 501. In FIG. 5C, punch holes 504 are formed above the image 501. In FIG. 5D, punch holes 505 are formed below the image 501. A position relative to an image may be specified as the punch hole position, or the (right or left) edge or center of a document may be specified as illustrated in FIG. 9B.

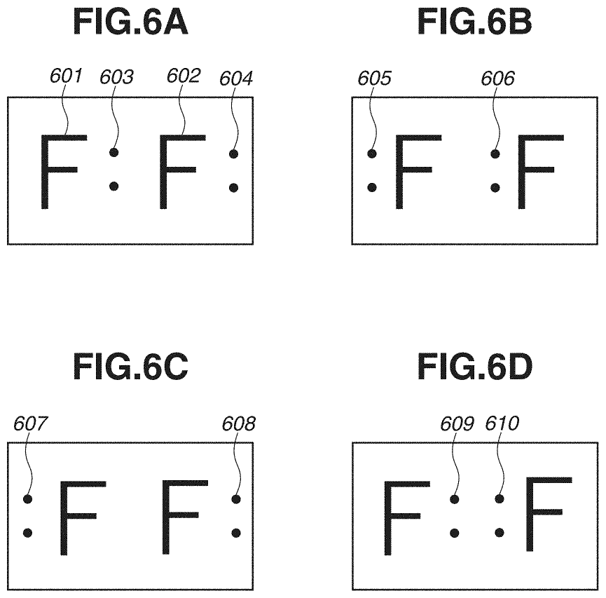

FIGS. 6A to 6D each illustrate another example of the output produced by the multifunctional puncher 3003 to which the two hole punching die 405 is attached.

In FIG. 6A, punch holes 603 and 604 are formed in two lines. More specifically, the punch holes 603 are formed in one line to the right of an image 601, and the punch holes 604 are formed in one line to the right of an image 602. In FIG. 6B, punch holes 605 and 606 are formed in two lines. More specifically, the punch holes 605 are formed in one line to the left of the image 601, and the punch holes 606 are formed in one line to the left of the image 602. In FIG. 6C, punch holes 607 and 608 are formed in two lines. More specifically, the punch holes 607 are formed in one line to the left of the image 601, and the punch holes 608 are formed in one line to the right of the image 602. In other words, the punch holes 607 in one line and the punch holes 608 in one line, two lines in total, are formed on the outer side of the sheet (in a direction perpendicular to the top-to-bottom direction of the sheet). In FIG. 6D, punch holes 609 and 610 are formed in two lines. More specifically, the punch holes 609 are formed in one line to the right of the image 601, and the punch holes 610 are formed in one line to the left of the image 602. In other words, the punch holes 609 in one line and the punch holes 610 in one line, two lines in total, are formed on the inner side of the sheet (in the direction perpendicular to the top-to-bottom direction of the sheet).

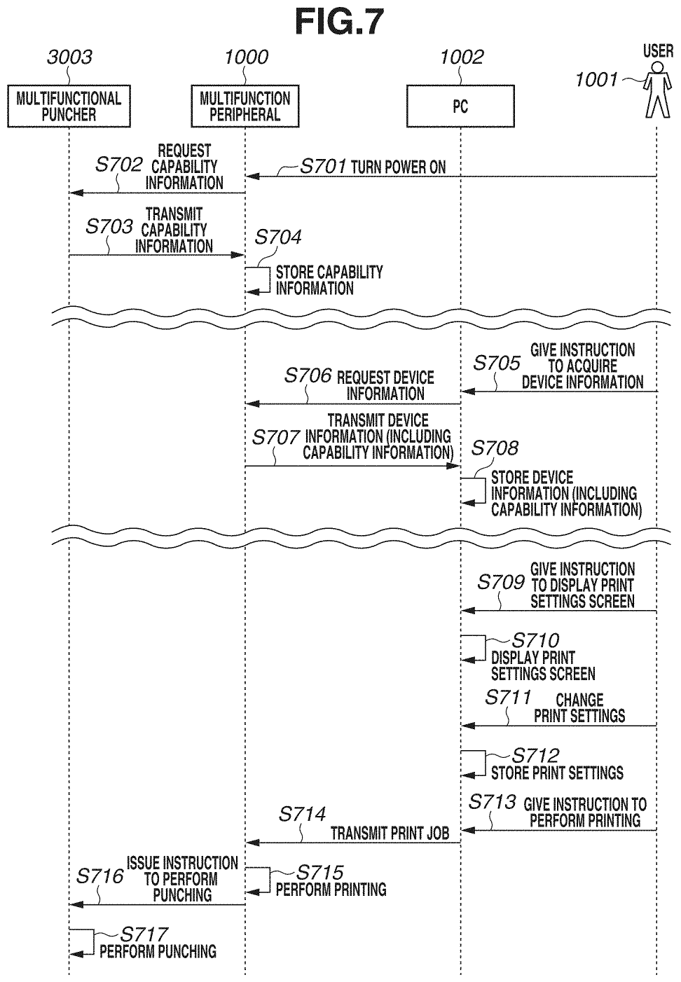

Next, a process to perform punching in a sheet on which an image is printed based on a received print job will be described with reference to a sequence diagram illustrated in FIG. 7.

FIG. 7 illustrates an example of a sequence in which a print job including punching is executed. In step S701, the sequence is started when the multifunction peripheral 1000 is powered on by a user 1001.

In step S702, the CPU 201 of the multifunction peripheral 1000 transmits a capability information acquisition request to the multifunctional puncher 3003 via the network I/F 205.

In step S703, the multifunctional puncher 3003 transmits capability information thereof to the multifunction peripheral 1000 based on the received capability information acquisition request.

In step S704, the multifunction peripheral 1000 receives the capability information from the multifunctional puncher 3003, and stores the received capability information in the HDD 204. The capability information includes information indicating the number of holes (such as two holes, three holes, four holes, or multiple holes) per line, information indicating punchable positions on the sheet (such as the leading edge, the trailing edge, the trailing edge of the first half, and the leading edge of the second half) relative to a conveyance direction of the sheet, and information indicating the number of lines in which punching can be performed.

In step S705, the user 1001 gives an instruction to acquire device information by using the PC 1002 at the time of installation of a page description language (PDL) driver or on a screen of the PDL driver. More specifically, displaying the top screen of the PDL driver on the PC 1002 is regarded as having given the instruction to acquire device information. Alternatively, displaying the print settings screen of the PDL driver may be regarded as having given the instruction to acquire device information.

In step S706, the CPU 301 of the PC 1002 transmits a device information acquisition request to the multifunction peripheral 1000 via the network I/F 205. The PC 1002 is connected to the multifunction peripheral 1000 via the network I/F 205.

In step S707, upon receiving the device information acquisition request, the CPU 201 of the multifunction peripheral 1000 transmits device information including the capability information stored in the HDD 204 in step S704 to the PC 1002. The capability information included in the device information and transmitted to the PC 1002 includes a list representing combinations of punching positions (e.g., “the trailing edge and the trailing edge of the first half of the sheet”, and “the trailing edge only”). This list is generated based on the information indicating the number of holes that can be punched, the information indicating the punchable positions on the sheet relative to the conveyance direction, and the information indicating the number of lines in which punching can be performed, which are stored in the HDD 204. Here, the punching position is a position where the multifunctional puncher 3003 can form a plurality of punch holes, and is a position in a direction orthogonal to a direction in which the plurality of punch holes is to be aligned.

Subsequently, in step S708, the CPU 301 of the PC 1002 stores the received device information in the HDD 304.

Here, the device information includes not only punching capability information but also, for example, stapling capability information (e.g., information indicating whether stapling is permitted, and information indicating a position where stapling can be performed).

In step S709, the user 1001 gives an instruction to display the print settings screen of the PDL driver by using the PC 1002. In response to the instruction, in step S710, the PC 1002 generates the print settings screen based on the device information stored in step S708, and displays the generated print settings screen. If the print settings screen is displayed in step S705, step S709 is omitted. The print settings screen displays an object for accepting a setting made by the user based on the punching capability information included in the device information. A specific example thereof will be described in detail with reference to FIGS. 9A and 9B.

FIGS. 9A and 9B each illustrate an example of a menu for setting punching. The menu illustrated in each of FIGS. 9A and 9B is an object in a screen that is displayed on the display device 308, which is connected to the PC 1002, when the PC 1002 executes the printer driver. The menu of FIG. 9A is used to select the type of punching. The user can select the type of punching from a list 912 in a pull-down menu 911. An “OFF” option 913 can be selected to disable punching. A “MULTI-HOLE” option 914 can be selected to perform single punching (for punching holes in one line). A “MULTI-HOLE (DOUBLE)” option 915 can be selected to perform double punching (for punching holes in two lines). In the list 912 of FIG. 9A, both the “MULTI-HOLE” option 914 and the “MULTI-HOLE (DOUBLE)” option 915 are displayed, and these options are displayed based on the capability information included in the device information received by the PC 1002 in step S707. More specifically, both the “MULTI-HOLE” option 914 and the “MULTI-HOLE (DOUBLE)” option 915 are displayed in a case where information indicating that the multifunctional puncher 3003 can perform both single punching and double punching is included in the capability information received from the multifunction peripheral 1000. In a case where information indicating that the multifunctional puncher 3003 can perform only single punching is included in the capability information received from the multifunction peripheral 1000, only the “OFF” option 913 and the “MULTI-HOLE” option 914 are displayed in the list 912 of FIG. 9A. In a case where the capability information includes information indicating that double punching cannot be performed, the PDL driver on the PC 1002 may interpret this as meaning that only single punching can be performed. In a case where the capability information does not include information indicating that double punching can be performed, the PDL driver may interpret this as meaning that only single punching can be performed.

In a case where the “MULTI-HOLE (DOUBLE)” option 915 is selected in the pull-down menu 911 of FIG. 9A, a punch hole position can be selected from a list 922 illustrated in FIG. 9B.

The menu of FIG. 9B is used to select a punch hole position, and the user can select a desired one from the list 922 including four types of punch hole positions in a pull-down menu 921. The punch hole position that can be selected in the pull-down menu 921 is a position where the multifunctional puncher 3003 can form a plurality of punch holes, and is a position in the direction orthogonal to the direction in which the plurality of punch holes is to be aligned. In other words, the punch hole position is a position where the multifunctional puncher 3003 can form a plurality of punch holes, and is a position in the direction orthogonal to the direction in which the punching blades are aligned.

Examples of options regarding the punch hole position include a “SHORT EDGE (LEFT)” option 923, a “SHORT EDGE (RIGHT)” option 924, a “SHORT EDGE (CENTER)” option 925, and a “SHORT EDGE (SIDE)” option 926. The “SHORT EDGE (LEFT)” option 923 can be selected to perform punching so that punch holes are 10206405US01 aligned to the left of an image. More specifically, when the “SHORT EDGE (LEFT)” option 923 is selected, the output illustrated in FIG. 6B is produced.

The “SHORT EDGE (RIGHT)” option 924 can be selected to perform punching so that punch holes are aligned to the right of an image. More specifically, when the “SHORT EDGE (RIGHT)” option 924 is selected, the output illustrated in FIG. 6A is produced.

The “SHORT EDGE (CENTER)” option 925 can be selected to perform punching so that punch holes are aligned at the center of a sheet. More specifically, when the “SHORT EDGE (CENTER)” option 925 is selected, the output illustrated in FIG. 6D is produced.

The “SHORT EDGE (SIDE)” option 926 can be selected to perform punching so that punch holes are aligned on the side edges of a sheet. More specifically, when the “SHORT EDGE (SIDE)” option 926 is selected, the output illustrated in FIG. 6C is produced.

Similar to the list 912 of FIG. 9A, the list 922 of FIG. 9B is displayed based on the capability information received in step S707. For example, the “SHORT EDGE (CENTER)” option 925 is not displayed in the list 922 in a case where information indicating that stapling cannot be performed at the center of a sheet is included in the capability information received in step S707. The list 922 may be configured not to display the “SHORT EDGE (CENTER)” option 925 in a case where information indicating that stapling can be performed at the center of a sheet is not included in the capability information received in step S707.

In step S711, the user 1001 changes the print settings of the PDL driver on the PC 1002. Subsequently, in step S712, the CPU 301 of the PC 1002 stores the print settings in the RAM 303 or the HDD 304.

In step S713, the user 1001 gives an instruction to perform printing.

Subsequently, in step S714, a print job including the print settings stored in step S712 and image data is transmitted from the PC 1002 to the multifunction peripheral 1000 via the LAN 211.

In step S715, the CPU 201 of the multifunction peripheral 1000 controls the printer 104 based on the received print job, so that the printer 104 performs printing. In step S716, in a case where punching is specified in the print settings, the CPU 201 of the multifunction peripheral 1000 issues an instruction to perform punching to the multifunctional puncher 3003.

In step S717, the multifunctional puncher 3003 performs punching based on the punching instruction received from the multifunction peripheral 1000.

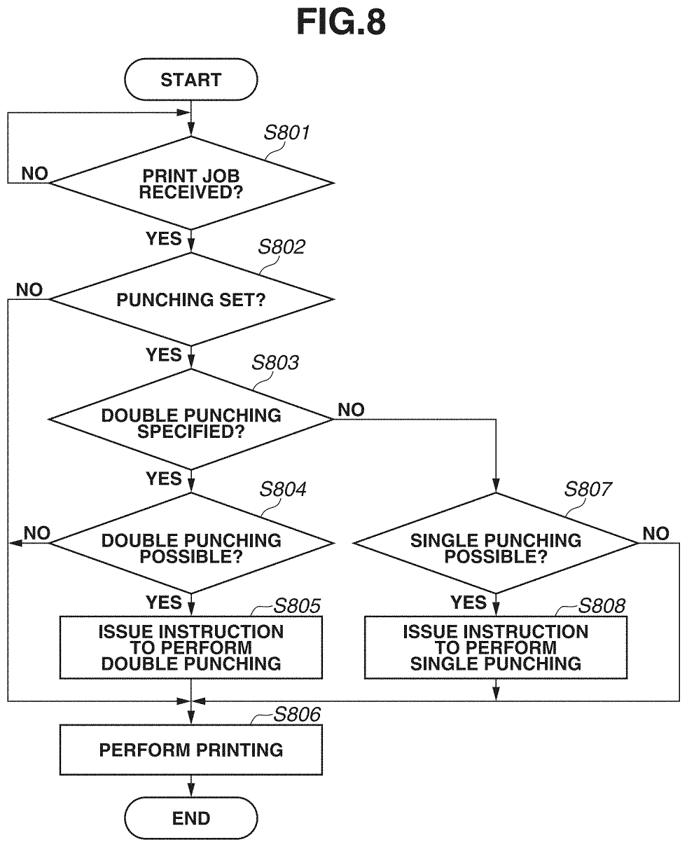

Next, a punching process performed by the multifunction peripheral 1000 according to the present exemplary embodiment will be described with reference to FIG. 8. FIG. 8 is a flowchart illustrating an example of the punching process. The process in the flowchart is implemented by the CPU 201 reading out a PDL function program from the ROM 202 or the HDD 204, loading the program into the RAM 203, and executing the program. The process of FIG. 8 is started when the multifunction peripheral 1000 is powered on.

In step S801, the CPU 201 of the multifunction peripheral 1000 determines whether a print job is received. If the CPU 201 determines that a print job is received (YES in step S801), the process proceeds to step S802. If not (NO in step S801), the process remains in step S801. The job received in step S801 is, for example, a print job transmitted from the PC 1002 to the multifunction peripheral 1000 by operating the printer driver on the PC 1002. In the case of a print job for performing double punching, the number of lines for punching is two, and the punching position is set as, for example, “the trailing edge and the trailing edge of the first half of the sheet”.

In step S802, the CPU 201 determines whether punching is set in print settings included in the print job received in step S801. If the CPU 201 determines that punching is set (YES in step S802), the process proceeds to step S803. If not (NO in step S802), the process proceeds to step S806.

In step S803, the CPU 201 determines whether double punching (for punching holes in two lines) is specified in the print settings included in the print job received in step S801. If the CPU 201 determines that double punching is specified (YES in step S803), the process proceeds to step S804. If not (NO in step S803), the process proceeds to step S807.

In step S804, the CPU 201 determines whether double punching can be performed. Whether double punching can be performed is determined based on the capability information of the multifunctional puncher 3003 that is acquired from the puncher controller unit 107 via the device controller I/F 208 and the printer controller unit 102 at startup and is stored in the RAM 203. If the CPU 201 determines that double punching can be performed (YES in step S804), the process proceeds to step S805. If not (NO in step S804), the process proceeds to step S806.

In step S805, the CPU 201 issues an instruction to perform double punching to the puncher controller unit 107 via the device controller I/F 208 and the printer controller unit 102.

In step S807, the CPU 201 determines whether single punching (for punching holes in one line) can be performed. Whether single punching can be performed is determined based on the capability information of the multifunctional puncher 3003 that is acquired from the puncher controller unit 107 via the device controller I/F 208 and the printer controller unit 102 at startup and is stored in the RAM 203. If the CPU 201 determines that single punching can be performed (YES in step S807), the process proceeds to step S808. If not (NO step S807), the process proceeds to step S806.

In step S808, the CPU 201 issues an instruction to perform single punching to the puncher controller unit 107 via the device controller I/F 208 and the printer controller unit 102.

In step S806, the CPU 201 controls the printer 104 via the printer controller unit 102 to print an image corresponding to the image data included in the print job on a sheet. In a case where the instruction to perform double punching is issued in step S805 or the instruction to perform single punching is issued in step S808, the puncher controller unit 107 operates the multifunctional puncher 3003 to perform punching in the sheet with the image printed thereon, based on the instruction. In addition, the multifunctional puncher 3003 performs punching in the sheet with the image printed thereon, based on the punch hole position specified on the print settings screen.

In the present exemplary embodiment, the example in which punching is set using the PDL driver on the PC 1002 when the print job is transmitted from the PC 1002 to the multifunction peripheral 1000 has been described, but the present exemplary embodiment is not limited to this example. For example, the user may set punching via the operation unit 106 of the multifunction peripheral 1000 when executing a copy job via the operation unit 106. In this case, the menu illustrated in each of FIGS. 9A and 9B is displayed on the operation unit 106 of the multifunction peripheral 1000 as a copy settings menu, and the selection made by the user is accepted via the operation unit 106. In this case as well, the screen illustrated in each of FIGS. 9A and 9B is displayed on the operation unit 106 based on the capability information received from the multifunctional puncher 3003 connected to the multifunction peripheral 1000.

Furthermore, while in the present exemplary embodiment, the multifunction peripheral 1000 and the multifunctional puncher 3003 have been described as separate apparatuses, the multifunction peripheral 1000 may incorporate the multifunctional puncher 3003. In this case, the capability information of the multifunctional puncher 3003 is pre-stored in the HDD 204 of the multifunction peripheral 1000. Thus, in a case where a device information acquisition request is received from the PC 1002, device information including the capability information pre-stored in the HDD 204 is transmitted to the PC 1002.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may include one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2020-063777, filed Mar. 31, 2020, which is hereby incorporated by reference herein in its entirety.

What is claimed is:

1. A print system comprising:
a print apparatus configured to be connected to a puncher; and
an information processing apparatus configured to communicate with the print apparatus,
wherein the print apparatus includes:
a first transmission unit configured to transmit, to the information processing apparatus, information indicating a position where the puncher is configured to form a plurality of punch holes, wherein the position is a position in a direction orthogonal to a direction in which the plurality of punch holes is to be aligned,
a printing unit configured to print an image on a sheet, and
a control unit configured to control the puncher to form the plurality of punch holes in the sheet on which the image is printed by the printing unit,
wherein the information processing apparatus includes:
a first reception unit configured to receive the information transmitted by the first transmission unit,
an acceptance unit configured to accept a setting that is based on the transmitted information received by the first reception unit, and
a second transmission unit configured to transmit the setting accepted by the acceptance unit to the print apparatus, and
wherein the control unit of the print apparatus controls the puncher to form the plurality of punch holes according to the setting transmitted by the second transmission unit of the information processing apparatus and received by the print apparatus.

2. The print system according to claim 1,
wherein the information processing apparatus further includes a display unit configured to display a predetermined screen based on the transmitted information received by the first reception unit, and
wherein options regarding the position are displayed on the predetermined screen, and the second transmission unit transmits, to the print apparatus, information indicating a position selected from the options by a user of the information processing apparatus.

3. The print system according to claim 2, wherein, in a case where information indicating a predetermined position is not included in the transmitted information received by the first reception unit of the information processing apparatus, the display unit displays the options without displaying the predetermined position.

4. The print system according to claim 1,
wherein the print apparatus further includes an acquisition unit configured to acquire, from the puncher, the information indicating the position where the puncher is configured to form the plurality of punch holes, and the position is the position in the direction orthogonal to the direction in which the plurality of punch holes is to be aligned, and
wherein the first transmission unit of the print apparatus transmits the information acquired by the acquisition unit to the information processing apparatus.

5. The print system according to claim 4, wherein the acquisition unit of the print apparatus acquires the information from the puncher when the print apparatus is powered on.

6. The print system according to claim 1, wherein the first transmission unit of the print apparatus further transmits, to the information processing apparatus, information indicating a number of the plurality of punch holes that the puncher is configured to form.

7. The print system according to claim 1, wherein the first transmission unit of the print apparatus transmits the position information via a network.

8. A print apparatus configured to be connected to a puncher and communicate with an information processing apparatus, the print apparatus comprising:
a transmission unit configured to transmit, to the information processing apparatus, information indicating a position where the puncher is configured to form a plurality of punch holes, wherein the position is a position in a direction orthogonal to a direction in which the plurality of punch holes is to be aligned;
a printing unit configured to print an image on a sheet; and
a control unit configured to control the puncher to form the plurality of punch holes in the sheet on which the image is printed by the printing unit,
wherein the control unit controls the puncher to form the plurality of punch holes according to a setting that is based on the information transmitted from the transmission unit to the information processing apparatus and received by the information processing apparatus.

9. The print apparatus according to claim 8,
wherein the print apparatus further includes an acquisition unit configured to acquire, from the puncher, the information indicating the position where the puncher is configured to form the plurality of punch holes, and the position is the position in the direction orthogonal to the direction in which the plurality of punch holes is to be aligned, and
wherein the transmission unit transmits the information acquired by the acquisition unit to the information processing apparatus.

10. The print apparatus according to claim 9, wherein the acquisition unit acquires the information from the puncher when the print apparatus is powered on.

11. The print apparatus according to claim 8, wherein the transmission unit transmits the position information via a network.

12. The print apparatus according to claim 8, wherein the information transmitted by the transmission unit to the information processing apparatus is used, by the information processing apparatus, for setting of print processing using the puncher.

13. The print apparatus according to claim 8,
wherein the transmission unit further transmits, to the information processing apparatus, information indicating a position where the puncher is not configured to form the plurality of punch holes, and
wherein an option, based on the information indicating the position where the puncher is not configured to form the plurality of punch holes, is not displayed by the information processing apparatus.

14. An information processing apparatus configured to communicate with a print apparatus, wherein the print apparatus is configured to be connected to a puncher, the information processing apparatus comprising:
a reception unit configured to receive, from the print apparatus, information indicating a position where the puncher is configured to form a plurality of punch holes, wherein the position is a position in a direction orthogonal to a direction in which the plurality of punch holes is to be aligned;
an acceptance unit configured to accept a setting that is based on the information received by the reception unit; and
a transmission unit configured to transmit the setting accepted by the acceptance unit to the print apparatus.

15. The information processing apparatus according to claim 14, further comprising a display unit configured to display a predetermined screen based on the information received by the reception unit,
wherein options regarding the position are displayed on the predetermined screen, and the transmission unit transmits, to the print apparatus, information indicating a position selected from the options by a user of the information processing apparatus.

16. The information processing apparatus according to claim 15, wherein, in a case where information indicating a predetermined position is not included in the information received by the reception unit, the display unit displays the options without displaying the predetermined position.

17. The information processing apparatus according to claim 14, wherein the reception unit receives the information that is acquired from the puncher by the print apparatus when the print apparatus is powered on.

18. The information processing apparatus according to claim 14, the transmission unit transmits the setting to the print apparatus via a network.

19. A method for controlling a print apparatus configured to be connected to a puncher and communicate with an information processing apparatus, the method comprising:
transmitting, to the information processing apparatus, information indicating a position where the puncher is configured to form a plurality of punch holes, wherein the position is a position in a direction orthogonal to a direction in which the plurality of punch holes is to be aligned;
printing an image on a sheet; and
controlling the puncher to form the plurality of punch holes in the sheet on which the image is printed,
wherein the controlling includes controlling the puncher to form the plurality of punch holes according to a setting that is based on the information transmitted to the information processing apparatus and received by the information processing apparatus.

20. A method for controlling an information processing apparatus configured to communicate with a print apparatus, wherein the print apparatus is configured to be connected to a puncher, the method comprising:
receiving, from the print apparatus, information indicating a position where the puncher is configured to form a plurality of punch holes, wherein the position is a position in a direction orthogonal to a direction in which the plurality of punch holes is to be aligned;
accepting a setting that is based on the received information; and
transmitting the accepted setting to the print apparatus.
